(19) United States
(12) Patent Application Publication
(10) Pub. No.: US 2025/0247116 A1
(43) Pub. Date: Jul. 31, 2025

(54) FRONT-END MODULE FOR A WIRELESS COMMUNICATION DEVICE

(71) Applicant: SKYWORKS SOLUTIONS, INC., Irvine, CA (US)

(72) Inventors: Kun Chen, Thousand Oaks, CA (US); Yu-Jui Lin, Westlake Village, CA (US)

(21) Appl. No.: 19/026,841

(22) Filed: Jan. 17, 2025

Related U.S. Application Data
(60) Provisional application No. 63/624,830, filed on Jan. 25, 2024.

(51) Int. Cl. H04B 1/00; H04B 1/04; H04B 1/10; H04B 1/12

(52) U.S. Cl. CPC H04B 1/0078; H04B 1/04; H04B 1/1036; H04B 1/12; H04B 2001/0408

(57) ABSTRACT

A front-end module comprising a signal input configured to receive a radio-frequency (RF) signal, an antenna switch module (ASM), a power amplifier adapted to amplify the received RF signal to provide an amplified RF signal supplied to the ASM by way of one or more RF signal paths, and a tunable filter with selective coupled resonances. The selective coupled resonances are adapted to filter the RF signal output by the ASM to provide a filtered RF signal at an antenna node forming a signal output of the front-end module and configured to be coupled to an antenna.

### CROSS-REFERENCE TO RELATED APPLICATIONS

This application claims priority under 35 U.S.C. § 119 (e) to U.S. Provisional Patent Application 63/624,830, titled FRONT-END MODULE FOR A WIRELESS COMMUNICATION DEVICE, filed on Jan. 25, 2024, and hereby incorporated by reference in its entirety for all purposes.

### TECHNICAL FIELD

Embodiments of the present disclosure relate to a front-end module of a wireless communication device with a tunable ASM filter and to a method for filtering of radio frequency signals.

### TECHNICAL BACKGROUND

Radio frequency (RF) communication systems can be used for transmitting and/or receiving signals of a wide range of frequencies. For example, an RF communication system can be used to wirelessly communicate RF signals in a frequency range from about 30 MHz to about 300 GHz, such as in the range of about 410 Megahertz (MHz) to about 7.125 gigahertz (GHz) for Fifth Generation (5G) cellular communications in Frequency Range 1 (FR1).

Examples of RF communication systems can include without limitation mobile phones, tablets, base stations, network access points, Customer-premises equipment (CPE), laptops, and wearable electronics. In certain applications, RF communications systems can process a plurality of RF signals concurrently. In such RF communications systems strong harmonic rejection can be desirable.

The innovations described herein each have several aspects, no single one of which is solely responsible for its desirable attributes. Without limiting the scope of the claims, prominent features of this disclosure will now be briefly described.

### SUMMARY

The present disclosure provides according to a first aspect a front end module comprising a signal input configured to receive a radio-frequency signal, a power amplifier adapted to amplify the received radio-frequency to provide an amplified radio-frequency signal supplied to an antenna switch module (ASM) by way of one or more radio frequency signal paths and a tunable filter with selective coupled resonances adapted to filter a radio-frequency signal output by the antenna switch module to provide a filtered radio-frequency signal at an antenna node forming a signal output of the front end module and configured to be coupled to an antenna.

In one example of the front-end module the tunable filter is adapted to provide harmonic rejection of harmonic frequencies of the radio-frequency signal output by said antenna switch module.

In another example of the front-end module, the tunable filter includes a first resonance circuit having a first inductor and a first capacitor being connected in parallel between a signal input and a signal output of said tunable filter.

In a further example of the front-end module, the tunable filter includes a second resonance circuit having a second inductor and a second capacitor connected in series to each other between the signal output of said tunable filter and a reference potential.

In some examples of the front-end module, the first resonance circuit and the second resonance circuit provide resonance frequencies of the tunable filter.

In some examples of the front-end module, a switchable filter element is connected to the first resonance circuit and to the second resonance circuit of the tunable filter.

In some examples of the front-end module, the switchable filter element is adapted to couple the resonance frequency of the first resonance circuit and the resonance frequency of the second resonance circuit.

In some examples of the front-end module, the switchable filter element is connected between the signal input of said tunable filter and a node between the second inductor and the second capacitor of the second resonance circuit.

In some examples of the front-end module, the switchable filter element includes a switchable capacitor.

In some examples, the first resonance circuit includes a tank circuit for rejecting the second harmonic frequency of the radio-frequency signal output by said antenna switch module. The tank circuit may be a parallel LC circuit connected in series.

In some examples, the second resonance circuit includes a trap circuit for rejecting the third harmonic frequency of the radio-frequency signal output by said antenna switch module. The trap circuit may be a series LC circuit connected in shunt.

In some examples, a trace is provided between the signal output of the tunable filter and the antenna node.

In some examples, the first capacitor of the first resonance circuit includes a switchable capacitance.

In some examples, the first inductor of the first resonance circuit includes a switchable inductance.

In some examples, an inductor is connected in series to the switchable filter capacitor.

In some examples, an inductor with switchable inductance is connected in parallel to the switchable capacitor.

In some examples, a third resonance circuit is connected between the coupled first and second resonance circuits and the signal output of the tunable filter.

In some examples, the third resonance circuit includes a third inductor and a third capacitor connected in parallel to each other.

In some examples, a fourth resonance circuit is connected between the coupled first and second resonance circuits and the signal input of the tunable filter.

In further examples, the fourth resonance circuit includes a forth inductor and a fourth capacitor connected in series to each other.

In some examples, the switchable capacitor is implemented as a silicon-on-insulator (SOI) element.

In some examples, the switchable capacitor includes a capacitor connected in series with a controllable switch.

In some examples, the controllable switch comprises a low off-capacitance in its switched-off state.

In some examples, the tunable filter is adapted to provide an impedance matching at a fundamental frequency of the radio-frequency signal output by said antenna switch module.

According to a further aspect of the disclosure a wireless communication device comprises a front-end module having a signal input configured to receive a radio-frequency signal. The front-end module includes a power amplifier adapted to amplify the received radio-frequency signal to provide an amplified radio-frequency signal supplied to an antenna switch module by way of one or more radio frequency signal paths. The front-end module further includes a tunable ASM filter with selective coupled resonances adapted to filter a radio-frequency signal output by the antenna switch module to provide a filtered radio-frequency signal at an antenna node forming a signal output of the front-end module and coupled to an antenna of said wireless communication device.

According to yet another aspect of the disclosure, a method for filtering radio frequency signals comprises amplifying a received radio-frequency signal to provide an amplified radio-frequency signal supplied to an antenna switch module by way of one or more radio frequency signal paths, and filtering the radio-frequency signal output by the antenna switch module by a tunable filter with selective coupled resonances to provide a filtered radio-frequency signal output to an antenna node.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or a group of advantages as taught herein without necessarily achieving other advantages as may be taught or suggested herein.

### BRIEF DESCRIPTION OF THE DRAWINGS

FIG. 1 shows a schematic diagram of a communication network;

FIGS. 2A to 2C show schematic diagrams for links using carrier aggregation;

FIG. 3 shows an exemplary dual connectivity network topology;

FIG. 4 shows a block diagram of an embodiment of a front-end module according to an aspect of the present invention;

FIG. 5 shows a block diagram of another embodiment of a front-end module according to an aspect of the present invention in more detail;

FIGS. 6 to 12, 13A, 13B show embodiments of a tunable ASM filter according to a further aspect of the present invention;

FIGS. 14A, 14B show implementations of switchable capacitors and switchable inductors used in a tunable ASM filter according to the present invention;

FIGS. 15A, 15B show an exemplary use case of a tunable ASM filter for different frequency bands;

FIG. 16 illustrates filtering characteristics of the tunable ASM filter;

FIG. 17 illustrates the filtering characteristics of the tunable ASM filter for different frequency bands;

FIG. 18 illustrates the filter characteristics compared to a transmission insertion loss;

FIGS. 19A, 19B show smith charts for S-parameters of the tunable ASM filter;

FIG. 20 shows a block diagram of an exemplary embodiment of a mobile device having a front-end module according to the present invention; and

FIG. 21 shows circuit diagrams for illustrating implementations of switches within a tunable ASM filter according to the present invention.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, same embodiments can incorporate any suitable combination of features from one or more drawings. The headings provided herein are for convenience only and are not intended to affect the scope of the claims.

The International Telecommunication Union (ITU) is a specialized agency of the United Nation (UN) responsible for global issues concerning Information and communication technologies, including the shared global use of radio spectrum.

The 3rd Generation Partnership Project (3GPP) is a collaboration between groups of telecommunications standard bodies across the World, such as the Association of Radio Industries and Businesses (ARIB), the Telecommunications Technology Committee (TTC), the China Communications Standards Association (CCSA), the Alliance for Telecommunications Industrial Solutions (ATIS), the Telecommunications Technology Association (TTA), the European Telecommunications Standards Institute (ETSI), and the Telecommunications Standards Development Society, Indio (TSDSI).

The ITU, 3GPP develops and maintains technical specifications for a variety of mobile communication technologies. These include, for example, second generation (2G) technology (for instance, Global System for Mobile Communications (GSM) and Enhanced Data Rates for GSM Evolution (EDGE), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced). The technical specifications controlled by 3GPP can be expanded and revised by specification releases, which can span multiple years and a breadth of new features and evolutions.

In one example, 3GPP introduced carrier aggregation (CA) for LTE in Release 10. Although initially introduced with downlink carriers, 3GPP expanded carrier aggregation in Release 14 to include downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP has introduced Phase 1 of fifth generation (5G) technology in Release 15, and has introduced Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data routes, supporting such features can pose a number of challenges.

The teachings herein are applicable to a wide variety of communication systems, including, but not limited to communication systems using advanced cellular technologies, such as LTE-Advanced, LTE-Advanced Pro, ad/or 5G NR.

### Harmonic Rejection

With fifth generation (5G) New Radio (NR) technology, harmonic rejection specifications can be increasingly more difficult to meet. With more integration, signals for more bands can be generated concurrently. More ability to meet various 5G NR harmonic specifications is desirable in a variety of applications. Examples of such applications include carrier aggregation applications, dual connectivity applications, applications with coexistence of a 5G NR FR signal and a 5G NR FROR Signal, other applications with co-existence, and the like.

Some conventional solutions include switches to tune harmonic rejection. In such solutions, one switch can control harmonic states, typically switching between bands. With such technology, N switches can control up to N harmonic states. With many bands present, a relatively large number of switches can be used to achieve the desired harmonic rejections. The relatively large number of switches can be costly to implement.

Filters disclosed herein can filter any suitable harmonics. For example, filters disclosed herein can filter one or more of the following harmonics: second harmonic, third harmonic, fourth harmonic, fifth harmonic, sixth harmonic, etc.

While embodiments may be discussed with reference to harmonic rejection, any suitable principles and advantages of the filters disclosed herein can be used to provide any suitable out-of-band rejection and/or filtering.

### Communication Network

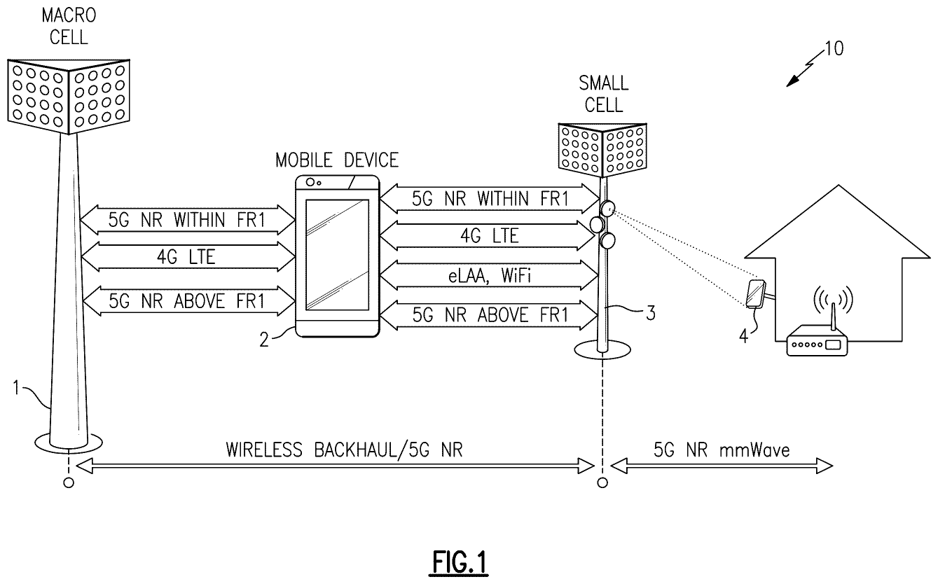

FIG. 1 is a schematic diagram of on example of a communication network 10, where the front-end module (FEM) according to the present disclosure can be used. The communication network 10 includes a macro cell base station 1, a mobile device 2, a small cell base station 3, and a stationary wireless device 4.

The illustrated communication network 10 of FIG. 1 supports communications using a variety of technologies, including, for example, 4G LTE, 5G NR, and wireless local area network (WLAN), such as Wi-Fi. In the communication network 10, dual connectivity can be implemented with concurrent 4G LTE and 5G NR communication with the mobile device 2. Although various examples of supported communication technologies are shown, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 1, the mobile device 2 communicates with the macro-cell base station 1 over a communication link that uses a combination of 4G LTE and 5G NR technologies. The mobile device 2 also communicates with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 1 and the small cell base station 3 using 5G NR technology over one or more frequency bands that within Frequency Range 1 (FR1) and/or over one or more frequency bands that are above FR1. The one or more frequency bands within FR1 can be less than 6 GHz. For example, wireless communications can utilize Frequency Range FR1, Frequency Range 2 (FROR) or a combination thereof. In one embodiment, the mobile device 2 supports a HPUE power class specification.

The illustrated small cell base station 3 also communicates with a stationary wireless device 4. The small cell base station 3 can be used, for example, to provide broad-band service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

In certain implementations, the small cell base station 3 communicates with the stationary wireless device 4 using beamforming. For example, beamforming can be used to focus signal strength to overcome path loses, such as high loss associated with communicating over millimeter wave frequencies.

The communication network 10 of FIG. 1 includes the macro-cell base station 1 and the small cell base station 3. In certain implementations, the small cell base station 3 can operate with relatively lower power, shorter range and/or with fewer concurrent users relative to the macro cell base station 1. The small cell base station 3 can also be referred to as a femtocell, a pico-cell, or a microcell.

Although the communication network 10 is illustrated as including two base stations, the communication network 10 can be implemented to include more or fewer base stations and/or base stations of other types. As shown in FIG. 1, base stations can communicate with one another using wireless communications to provide a wireless backhaul. Additionally or alternatively, base stations can communicate with on another using wired and/or optical links.

The communication network 10 of FIG. 1 is illustrated as including one mobile device 2 and one stationary wireless device 4. The mobile device 2 and the stationary wireless device 4 illustrate examples of user devices or user equipment (UE). Although the communication network 10 is illustrated as including two user devices, the communication network 10 can be used to communicate with more or fewer user devices and/or user devices of other types. For example, user devices can include mobile phones, tablets, laptops, IoT devices, wearable electronics, and/or a wide variety of other communications devices.

User devices of the communication network 10 can share available network resources (for instance, available frequency spectrum) in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

Enhanced mobile broadband (eMBB) refers to a technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than two milliseconds. uRLLC can be used for mission-critical communications such as for autonomous drilling and/or remote surgery applications.

The communication network 10 of FIG. 1 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennae used for communications.

For instance, in certain implementations, a data rate of a communication link can be about or equal to M*B*log 2(1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennae), using wider bandwidth (for instance, by aggregating carriers), and/or improving SNR (for instance, by increasing transmit power and/or improving receiver sensitivity). 5G NR communication systems can employ a wide variety of techniques for enhancing data rate and/or communication performance.

### Carrier Aggregation

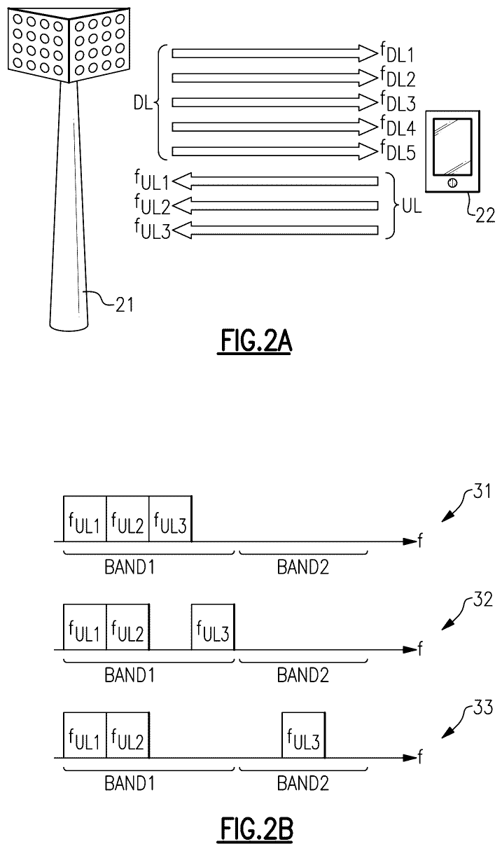

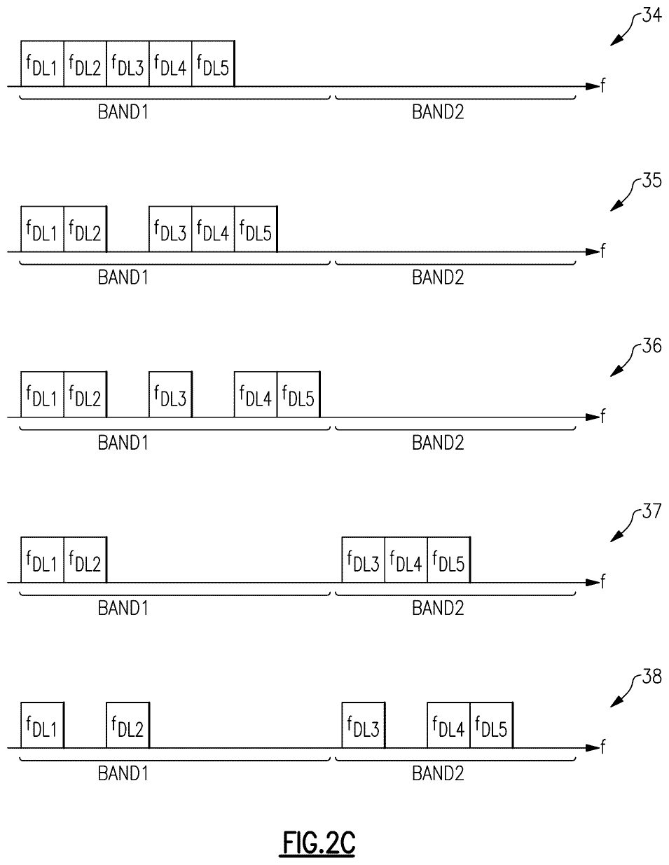

FIG. 2A is a schematic diagram of on example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations. Carrier aggregation can present challenges for harmonic rejection. Filters disclosed herein can be implemented to provide harmonic rejection in carrier aggregation applications. Radio frequency front end architectures disclosed herein can be implemented in dual connectivity applications.

In the illustrated example, the communication link is provided between a base station 21 and a mobile device 22. As shown in FIG. 2A, the communications link CL includes a downlink channel DL used for RF communications from the base station 21 to the mobile device 22, and an uplink channel UL used for RF communications from the mobile device 22 to the base station 21.

Although FIG. 2A illustrates carrier aggregation in the context of FDD communications, carrier aggregation can also be used for TDD communications.

In certain implementations, a communication link CL can provide asymmetrical data rates for a downlink channel DL and an uplink channel UL. For example, a communication link CL can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link CL. Carrier aggregation includes contiguous aggregation, in which contiguous carriers within the same operation frequency band are aggregated. Carrier aggregation can also be non-contiguous, and can include carriers separated in frequency within a common band or in different bands.

In the example shown in FIG. 2A, the uplink channel UL includes three aggregated component carriers f_{UL1}, f_{UL2} and f_{UL3}. Additionally, the downlink channel DL includes five aggregated component carriers f_{DL1} to f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device data through the communication network and/or as network usage changes over time.

FIG. 2B illustrates various examples of uplink carrier aggregation for the communication link of FIG. 2A.

FIG. 2B includes a first carrier aggregation scenario 31, a second carrier aggregation scenario 32, and a third carrier aggregation scenario 33, which schematically illustrate three types of carrier aggregation.

The carrier aggregation scenarios 31-33 illustrate different spectrum allocations for a first component carrier f_{UL1}, a second component carrier f_{UL2} and a third component carrier f_{UL3}. Although FIG. 2B is illustrated in the in the context of aggregating three component carriers, carrier aggregation can be used to aggregate more or fewer carriers. Moreover, although illustrated in the context of uplink UL, the aggregation scenarios are also applicable to downlink DL.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2} and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts an aggregation of component carriers f_{UL1}, f_{UL2} and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4} and a fifth component carrier f_{DL5}. Although FIG. 2C is illustrated in the context of aggregating five component carriers, carrier aggregation can be used to aggregate more or fewer carriers. Moreover, although illustrated in the context of downlink DL the aggregation scenarios are also applicable to uplink UL.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, if the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

### Dual Connectivity

With the introduction of the 5G NR air interface standards, 3GPP has allowed for the simultaneous operation of 5G and 4G standards in order to facilitate the transition. This mode can be referred to as Non-Stand-Alone (NSA) operation or E-UTRAN New Radio-Dual Connectivity (EN-DC) and involves both 4G and 5G carriers being simultaneously transmitted from and/or received by a user equipment (UE). EN-DC can present challenges for harmonic rejection. Filters disclosed herein can be implemented to provide harmonic rejection in dual connectivity applications. Radio frequency front end architectures disclosed herein can be implemented in dual connectivity applications.

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

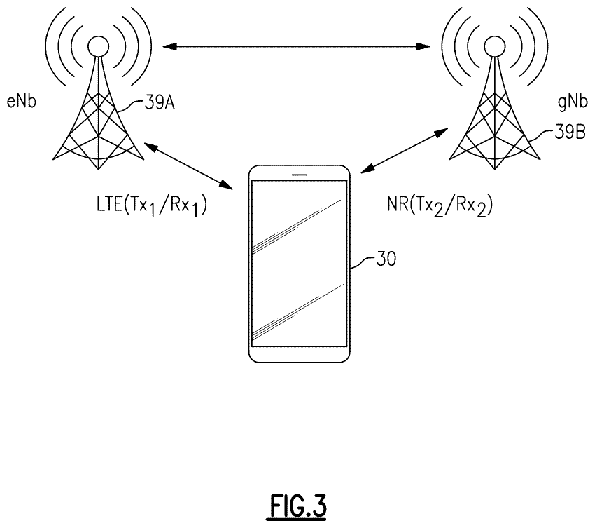

FIG. 3 is a diagram of an example dual connectivity network topology. This architecture can leverage LTE legacy coverage to ensure continuity of service delivery and the progressive rollout of 5G cells. A UE 30 can simultaneously transmit dual uplink LTE and NR carriers. The UE 30 can transmit an uplink LTE carrier Tx1 to the eNodeB (eNB) 39A while transmitting an uplink NR carrier Tx2 to the gNodeB (gNB) 39B to implement dual connectivity. Any suitable combination of uplink carriers Tx1, Tx2 and/or downlink carriers Rx1, Rx2 can be concurrently transmitted via wireless links in the example network topology of FIG. 3. The eNB 39A can provide a connection with a core network, such as an Evolved Packet Core (EPC). The gNB 39B can communicate with the core network via the eNB 39A. Control plane data can be wirelessly communicated between the UE 30 and eNB 39A. The eNB 39A can also communicate control plane data with the gNB 39B.

In the example dual connectivity topology of FIG. 3, any suitable combinations of standardized bands and radio access technologies (e.g., FDD, TDD, SUL, SDL) can be wirelessly transmitted and received. This can present technical challenges related to having multiple separate radios and bands functioning in the UE 30. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

In 5G NR and other applications, harmonic rejection specifications can be challenging to meet. Providing additional tunability for filters can help with meeting such harmonic rejection specifications. Harmonic rejection can be implemented in a variety of tunable filters provided within the front-end module (FEM) according to the present disclosure.

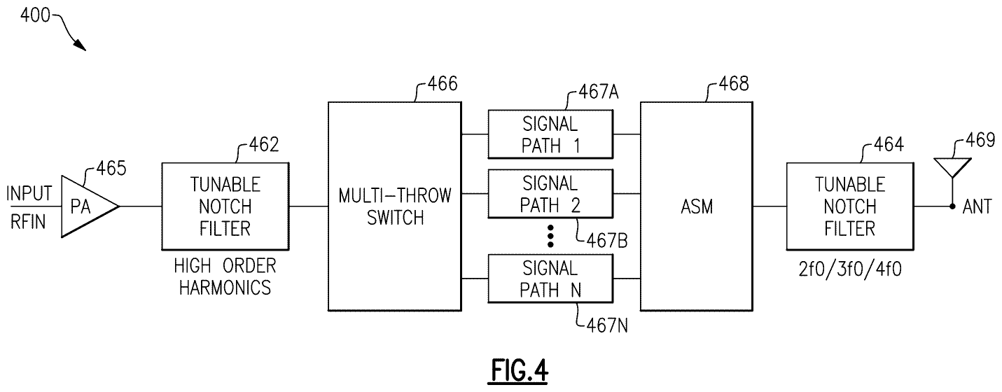

FIG. 4 is a schematic diagram of a radio-frequency front-end module (RF-FEM) 400 with filters. As illustrated, the RF-FEM 400 can include a first filter 462 and a second tunable ASM filter 464. The first filter 462 is coupled between an output of a power amplifier (PA) 465 and a multi-throw switch 466. The first filter 462 can comprise a tunable notch filter used for rejection of high order harmonics. The multi-throw switch 466 can be a band select switch BSW or any other suitable multi-path switch arranged to pass a radio-frequency signal. A plurality of signal paths 467A, 467B and 467N are coupled between the multi-throw switch 466 and an antenna switch module (ASM) 468. The signal paths 467A, 467B and 467N can provide filtering and/or other signal processing. As an example, the signal paths 467A, 467B, and 467N can each be arranged to process an RF signal within an operating band. In this example, the signal paths 467A, 467B, and 467N can each include a band pass filter associated with a different frequency band. The tunable ASM filter 464 is coupled between the antenna switch module 468 and an antenna node ANT. The antenna node ANT is a node at which the front-end circuitry is connected to the antenna 469.

The RF-FEM 400 of FIG. 4 includes a signal input RF in configured to receive a radio-frequency (RF) signal, a PA 465 is adapted to amplify the received radio-frequency signal to provide an amplified radio-frequency signal supplied to an ASM 468 by way of one or more RF signal paths. The tunable ASM filter 464 with selective coupled resonances is adapted to filter an RF signal output by the ASM 468 to provide a filtered radio-frequency signal at an antenna node ANT forming a signal output of the RF-FEM 400 and configured to be coupled to an antenna.

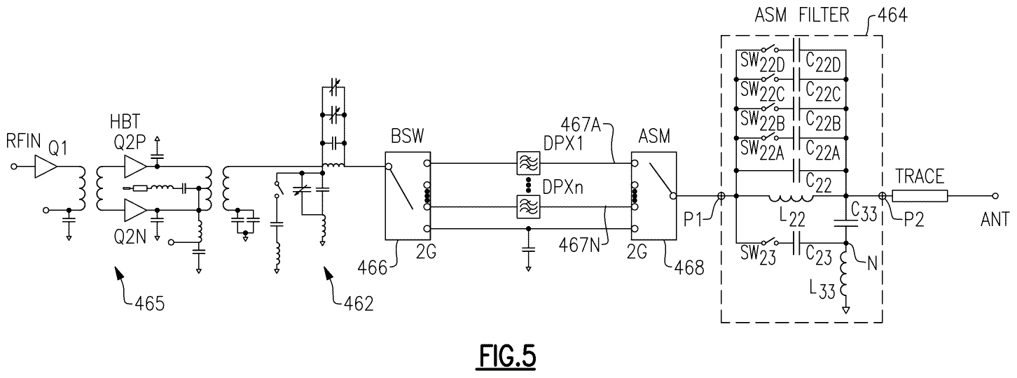

FIG. 5 illustrates an embodiment of the RF-FEM 400 shown in FIG. 4 in more detail. In the RF-FEM 400 of FIG. 5, the tunable ASM filter 464 is adapted to provide harmonic rejection of harmonic frequencies of the radio-frequency signal output by the ASM 468.

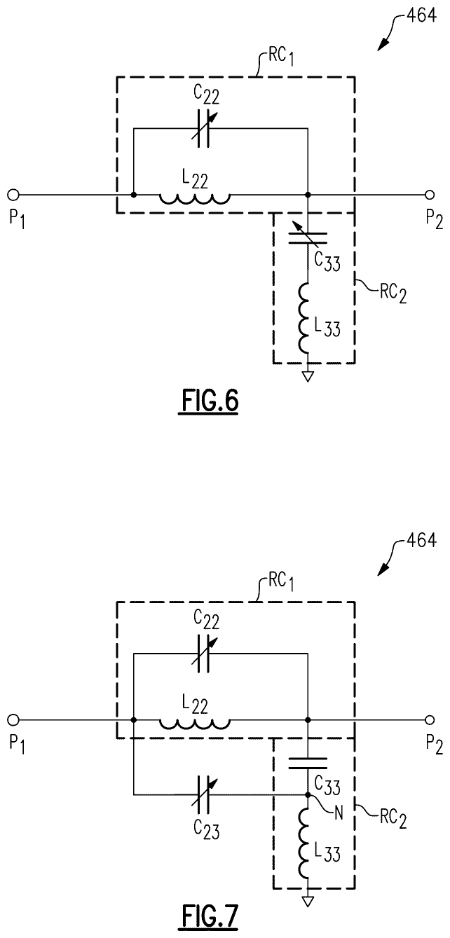

As shown in FIG. 5 and FIG. 6 the tunable ASM filter 464 comprises a first resonance circuit RC1 having a first inductor L22 and a first capacitor C22 being connected in parallel between a signal input P1 and a signal output P2 of the tunable ASM filter 464. The tunable ASM filter 464 comprises a second resonance circuit RC2 having a second inductor L33 and a second capacitor C33 connected in series to each other between the signal output P2 of said tunable ASM filter 464 and a reference potential. In the exemplary embodiment of FIG. 5, capacitors C22A to C22D can be switched by associated controllable switches SW22A to SW22D in parallel to capacitor C22 to increase the overall capacitance.

In the RF-FEM 400 of FIG. 5 the first resonance circuit RC1 and the second resonance circuit RC2 of the tunable ASM filter 464 are shown to provide resonance frequencies fR1,fR2 of the tunable ASM filter 464. In the RF-FEM 400 of FIG. 5, a switchable filter element is shown to be connected to the first resonance circuit RC1 and to the second resonance circuit RC2 of the tunable ASM filter 464. The switchable filter element is adapted to couple the resonance frequency fR1 of the first resonance circuit RC1 and the resonance frequency fR2 of the second resonance circuit RC2. The switchable filter element of the tunable ASM filter 464 is connected between the signal input P1 of the tunable ASM filter 464 and a node N provided between the second inductor L33 and the second capacitor C33 of the second resonance circuit RC2 as shown in FIG. 5.

The switchable filter element of the tunable ASM filter 464 may include a switchable or tunable capacitor C23 as illustrated in FIG. 7. The switchable or tunable capacitor C23 as illustrated in FIG. 7 may be connected in series with a controllable switch SW23 as also illustrated in FIG. 5. In at least one implementation of the RF-FEM 400, the switchable or tunable capacitor C23 is implemented as an element fabricated in silicon-on-insulator (SOI) technology.

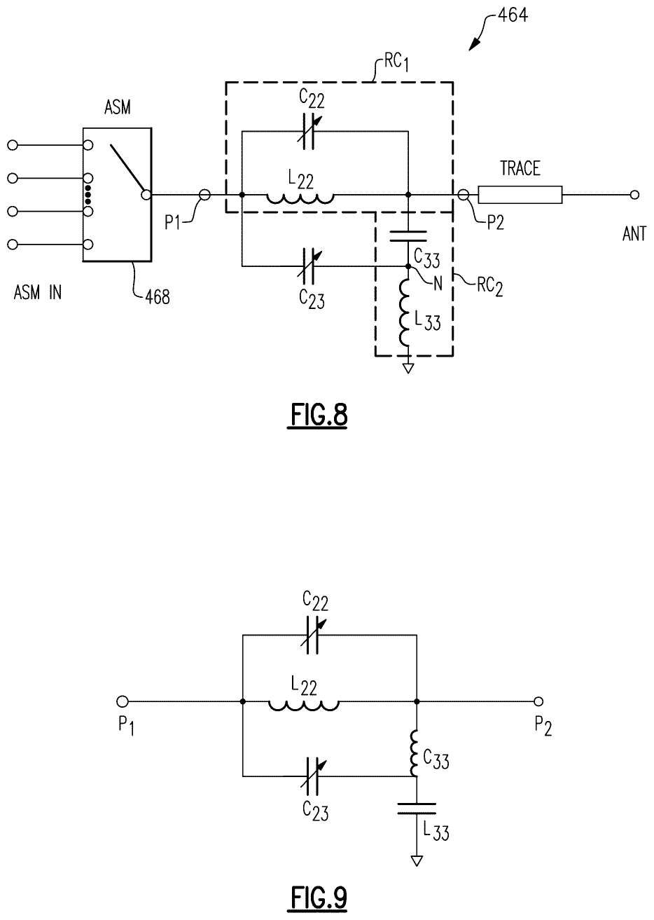

The first capacitor C22 of the first resonance circuit RC1 of the tunable ASM filter 464 may include a tunable or switchable capacitance as illustrated in the embodiments shown in FIG. 5 and FIG. 6. As illustrated in FIG. 8, a trace may be provided between the signal output P2 of the tunable ASM filter 464 and the antenna node ANT.

In one implementation depicted in FIG. 9, the second inductor L33 and the second capacitor C33 of the second resonance circuit RC2 as shown in FIG. 5 may be coupled in reversed order.

In the RF-FEM 400 of FIG. 5, the first resonance circuit RC1 is depicted to include a tank circuit for rejecting the second harmonic frequency (2fo) of the radio-frequency signal output by said antenna switch module (ASM) 468. In the RF-FEM 400 of FIG. 5, the second resonance circuit RC2 of the tunable ASM filter 464 may include a trap circuit for rejecting the third harmonic frequency (3fo) of the radio-frequency signal output by said antenna switch module (ASM) 468.

As illustrated in FIGS. 6 to 13, the tunable ASM filter 464 may include a first resonance circuit RC1 having a first inductor L22 and a first capacitor C22 being connected in parallel between a signal input P1 and a signal output P2 of said tunable ASM filter 464. The tunable ASM filter 464 illustrated in FIG. 6 includes a second resonance circuit RC2 having a second inductor L33 and a second capacitor C33 connected in series to each other between the signal output P2 of the tunable ASM filter 464 and a reference potential. In some implementations of the RF-FEM 400 of FIG. 4, the first resonance circuit RC1 and the second resonance circuit RC2 of the tunable ASM filter 464 shown in FIGS. 6 to 13 provide for resonance frequencies of the tunable ASM filter 464.

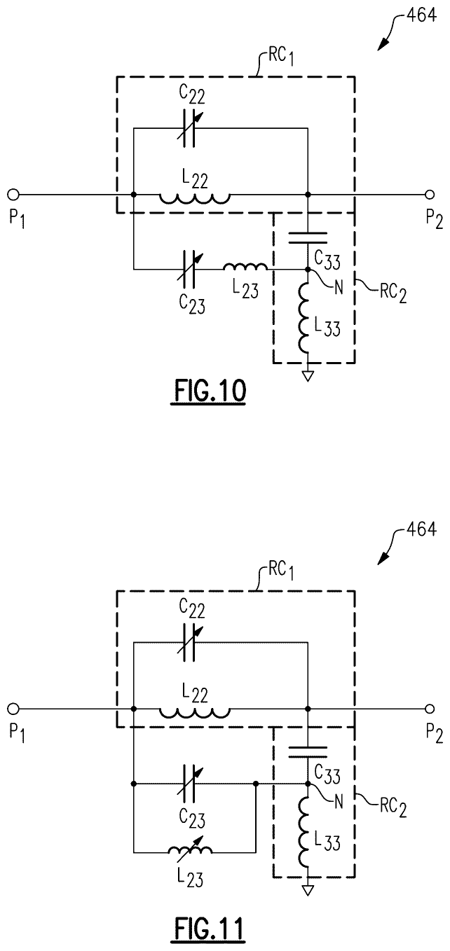

An inductor L23 may be connected in series to the switchable filter capacitor C23 of the tunable ASM filter 464 as illustrated in FIG. 10.

FIG. 11 illustrates an implementation of the RF-FEM 400 of FIG. 4 in which an inductor L23 with switchable or tunable inductance is connected in parallel to the switchable capacitor C23 of the tunable ASM filter 464.

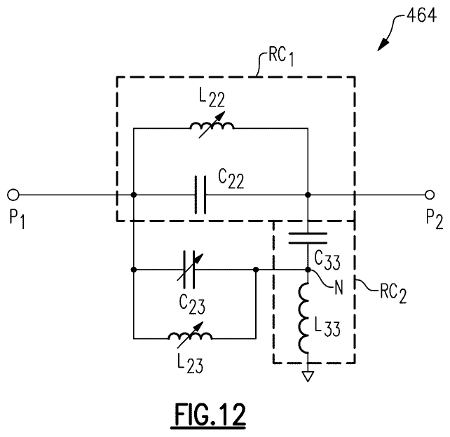

FIG. 12 illustrates another implementation of the RF-FEM 400 of FIG. 4 in which the first inductor L22 of the first resonance circuit RC1 of the tunable ASM filter 464 includes a switchable or tunable inductance.

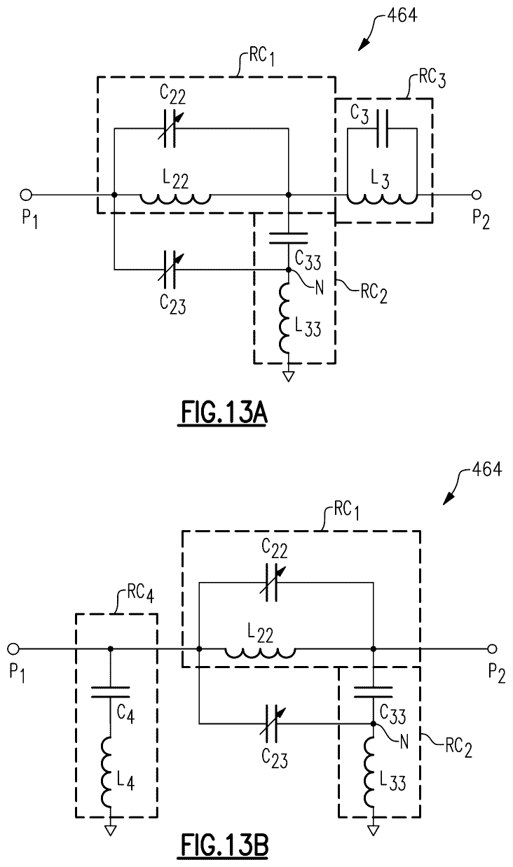

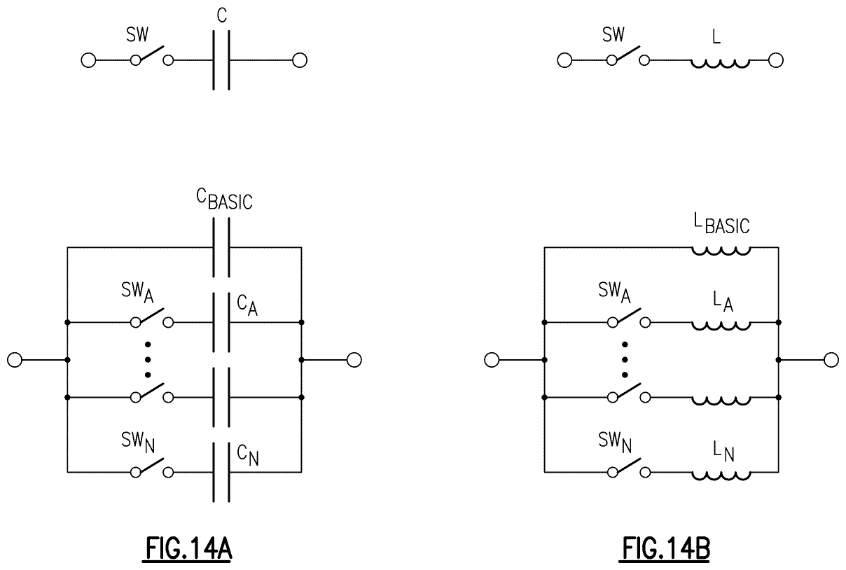

FIG. 13A illustrates another implementation of the RF-FEM 400 of FIG. 4 in which a third resonance circuit RC3 is connected between the coupled first and second resonance circuits RC1, RC2 and the signal output P2 of the tunable ASM filter 464. The third resonance circuit RC3 comprises a third inductor L3 and a third capacitor C3 connected in parallel to each other.

FIG. 13B illustrates another implementation of the RF-FEM 400 of FIG. 4 in which a fourth resonance circuit RC4 is connected between the coupled first and second resonance circuits and the signal input P1 of the tunable ASM filter 464. The fourth resonance circuit RC4 may include a fourth inductor L4 and a fourth capacitor C4 connected in series to each other.

FIGS. 14A and 14B illustrate various implementations of switchable or tunable capacitors C and switchable or tunable inductors L used in the ASM switch 464 as depicted in conjunction with FIGS. 5 and 6.

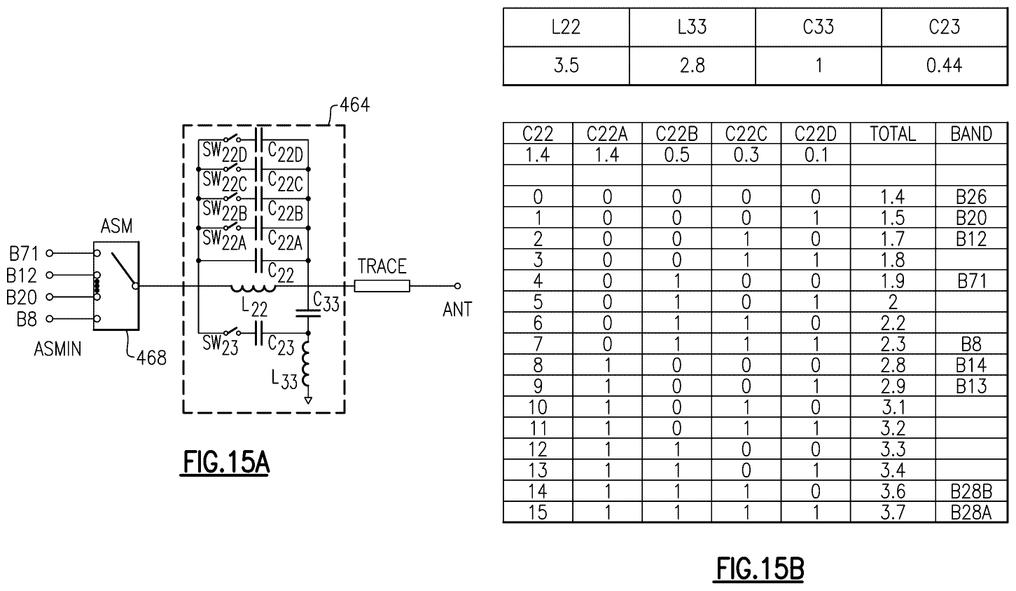

FIG. 15A illustrates an implementation of the tunable ASM filter 464 of the RF-FEM 400 of FIG. 4 with an associated table of frequency bands shown in FIG. 15B. The switchable capacitor C22 of the tunable ASM filter 464 includes a capacitor connected in series with a controllable switch SW23 as shown in FIG. 5 and in FIG. 15A. The controllable switch SW23 of the tunable ASM filter 464 comprises a low off-capacitance in its switched-off state.

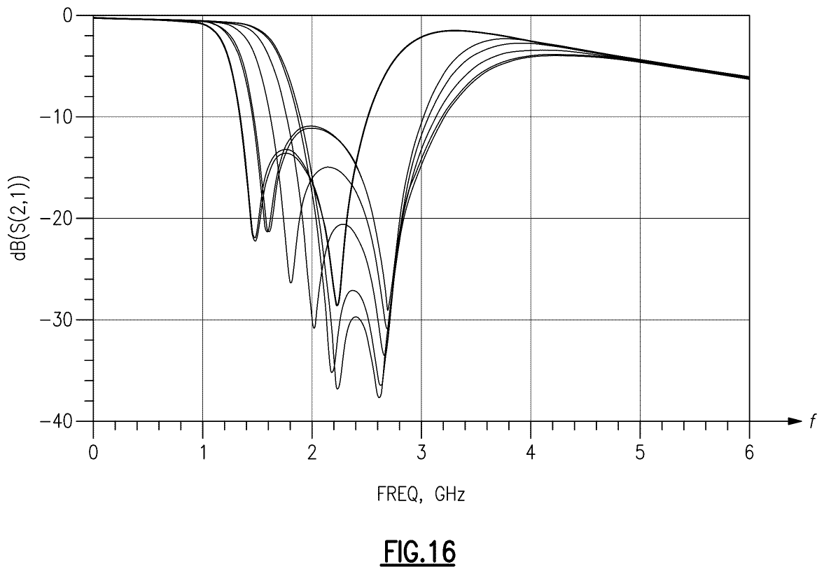

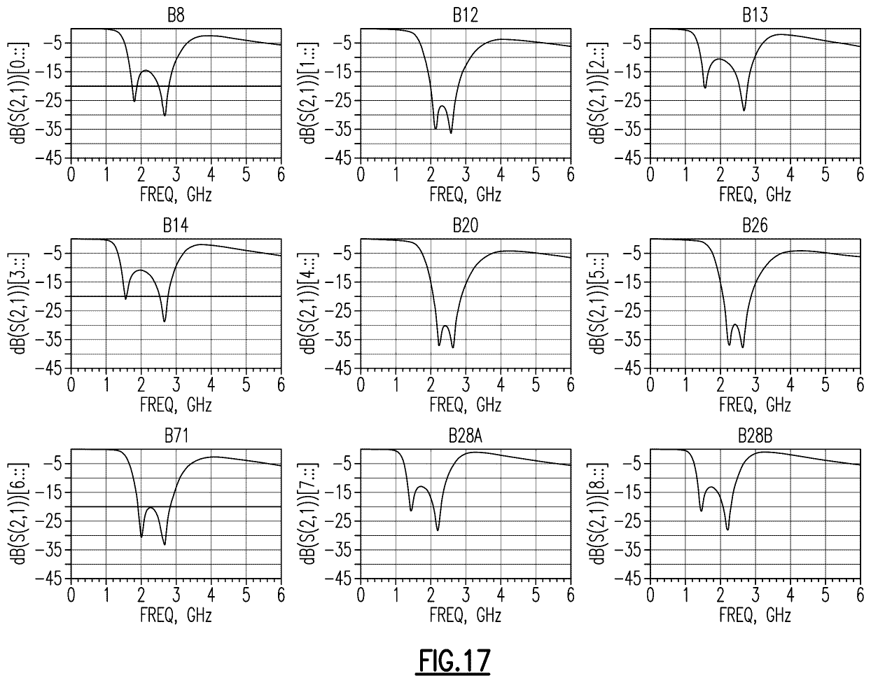

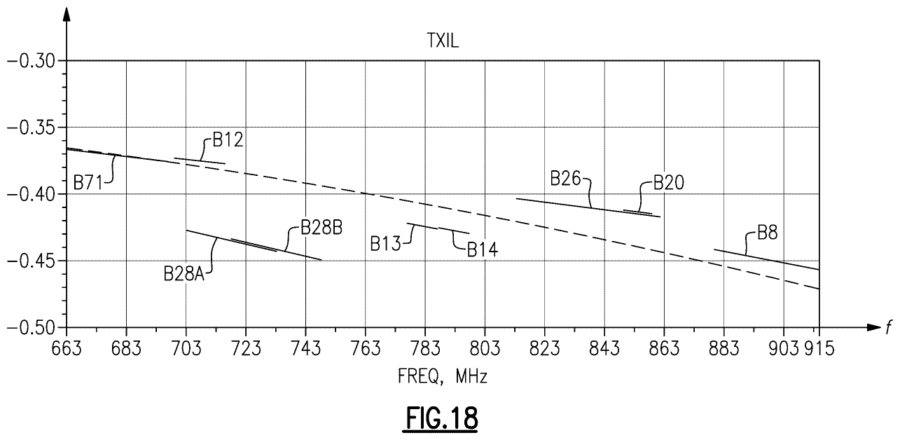

The switchable capacitor C22 comprises a basic fixed capacitance C22 to which additional capacitance C22A to C22D can be switched by means of controllable switch elements SW22A to SW22D to provide a total capacitance as illustrated in the table of FIG. 15B. Corresponding bands B26, B20, B12, B71, B8, B14, B13, B28B, B28A are also shown in the table of FIG. 15B and the diagrams of FIG. 16 and FIG. 17.

The table of FIG. 15B shows a specific exemplary implementation comprising an inductor L22 with an inductance value of 3.5 nH, an inductor L33 with an inductance value of 2.8 nH, a capacitor C33 with a capacitance value of 1 pF and a capacitor C23 with a capacitance value of 0.44 pF.

The capacitance of the basic capacitor C22 can be extended or increased by switching additional capacitors C22A to C22D in parallel to the basic capacitor C22 using switches SW22A to SW22D. In the illustrated implementation, the basic capacitor C22 has a capacitance value of 1.4 pF. The additional capacitors C22A, C22B, C22C and C22D have capacitance values of 1.4 pF, 0.5 pF, 0.3 pF, and 0.1 pF, respectively. If none of the four additional capacitances C22A to C22D is switched in parallel to the basic capacitors C22 (0000) the total capacitance is 1.4 pF used for frequency band B26 as illustrated in FIG. 15B. Four additional capacitors C22A to C22D provide for sixteen switching combinations (0 to 15) as illustrated in the table of FIG. 15B. Some switching combinations may not be used as illustrated in the example of FIG. 15B. In the illustrated example, the switching combination 0000 is used for band B26, 0001 is used for band B20, 0010 is used for band B12, 0100 is used for band B71, 0110 is used for band B8, 1000 is used for band B14, 1001 is used for band B13, 1110 is used for band B28A and 1111 is used for band B28B. Further for band B28A, B28B the switch SW23 is switched on to add the capacitance of capacitor C23 to the total capacitance of 3.7 pF (=1.4 pF (C22)+1.4 pF (C22A)+0.5 pF (C22B)+0.3 pF (C22C)+0.1 pF (C22D)). The switches and capacitors can be implemented on a die manufactured in silicon-on-insulator (SOI) technology while the inductors may be implemented in a multi-chip module (MCM) as SMDs or embedded coils. The switches SW can be controlled by a controller of the RF-FEM 400.

FIG. 16 shows a diagram illustrating the simulation of S-Parameter S21 for different frequency bands B of the tunable ASM filter 464 shown in FIG. 15A.

FIG. 17 shows the simulation of S21 for each of the frequency bands B8, B12, B13, B14,B20, B26, B71, B28A, and B28B. Each band B can have a different fundamental frequency f0. For instance, band B8 has a fundamental TX frequency fo=880 MHz-915 MHz, and rejects the 2nd and 3rd harmonics at 2fo (1,760 MHz-1,830 MHz) and 3fo (2,640 MHz-2,745 MHz). Band B12 has a fundamental TX frequency f0=699 MHz-716 MHz and rejects the 3^{rd} harmonic 3fo (2,097 MHz-2,148 MHz). The rejections of those harmonic frequencies fall into other bands as specified by 3GPP and the emission of such frequencies from the module antenna may deteriorate the noise levels in other modules in the phone operating on those frequencies.

FIG. 18 shows the filter capabilities for different frequency bands B in comparison to baseline TXIL (Transmission Insertion Loss).

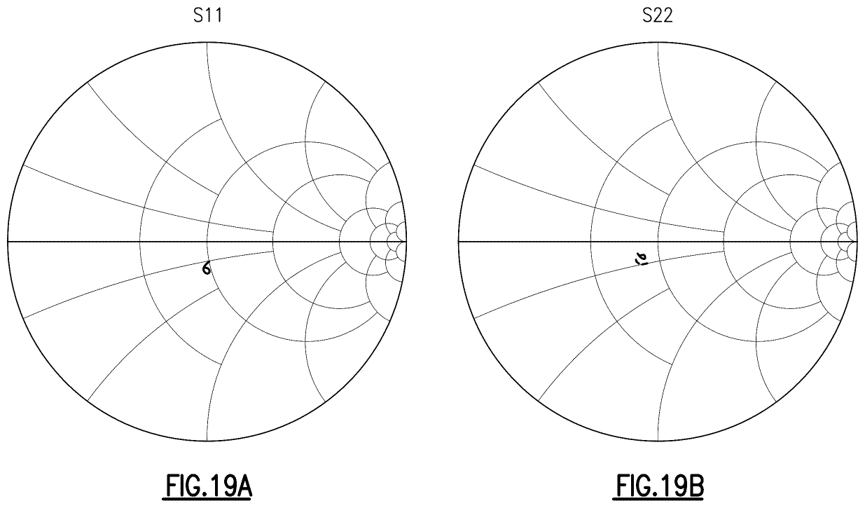

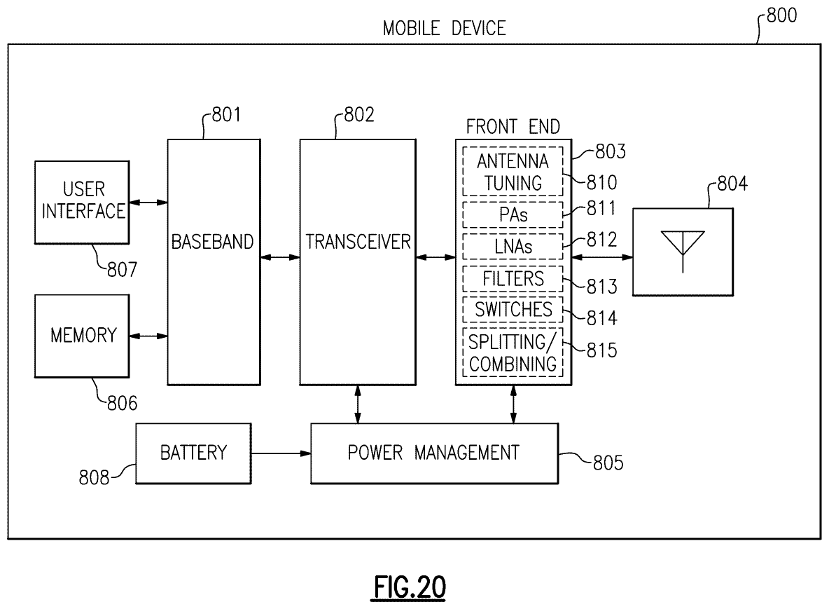

FIGS. 19A and 19B show smith charts for S-Parameter S11 (FIG. 19A) and S22 (FIG. 19B). As can be seen from FIGS. 19A and 19B, the clustering of the impedance Z for the different frequency bands is very tight.

The switches SW may be implemented by splitting them into smaller transistors, in particular MOSFETs as exemplarily illustrated in FIG. 21. The transistors can be connected in series or parallel to each other. Anti-series and anti-parallel connections (or their compositions) can be used to enhance linearity of the switch SW, for example to reduce harmonics, and in particular to reduce the harmonic of second order 2f0.

The tunable filters disclosed herein can be included in radio frequency systems, such as in a radio frequency front end. A tunable filter in accordance with any suitable principles and advantages disclosed herein be implemented at any suitable location in a system that can benefit from the harmonic rejections provided by filters disclosed herein.

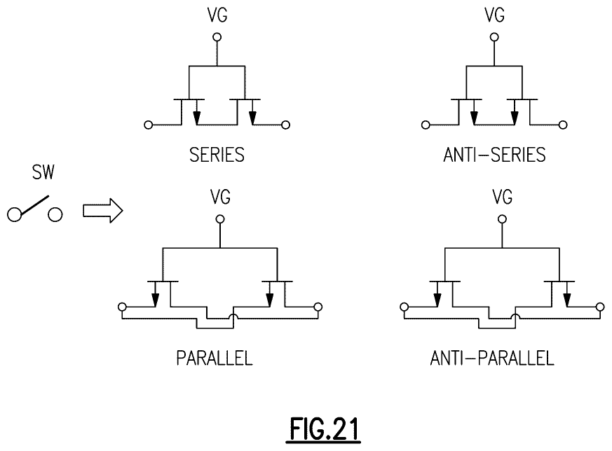

FIG. 20 depicts a wireless communication device 800 comprising a front-end module (FEM) 803 having a signal input configured to receive a radio-frequency (RF) signal. The FEM 803 of the wireless communication device 800 of FIG. 20 may in particular be the RF-FEM 400 as illustrated in conjunction with FIGS. 6 to 15. The RF-FEM 400 includes a power amplifier (PA) 465 adapted to amplify the received RF signal to provide an amplified radio-frequency signal. The power amplifier 465 may include a differential amplifier as illustrated in FIG. 5. The amplified RF signal is supplied via a transformer and a tunable notch filter 462 to a multi-path switch (band selective switch BSW) 466 as shown in FIGS. 4 and 5 and to an antenna switch module (ASM) 468 by way of one or more RF signal paths 467A to 467N as shown in FIGS. 4 and 5. Each of the RF signal paths 467A to 467N includes a band pass filter which can be implemented by a frequency division duplexer DPX.

The RF-FEM 400 further includes a tunable ASM filter 464 connected to the output of the ASM 468. The tunable ASM filter 464 comprises selective coupled resonances adapted to filter a radio-frequency signal output by the ASM 468 to provide a filtered radio-frequency signal at an antenna node ANT (antenna port) forming a signal output of the RF-FEM 400 and coupled to an antenna 804 of the mobile wireless communication device 800 shown in FIG. 20. The output of the ASM filter 464 can be connected through a trace to the antenna node ANT. The trace can be formed by a transmission line with a specific length and impedance.

The mobile wireless communication device 800 of FIG. 20 further includes a baseband system 801, a transceiver 802, the FEM 803, the antenna 804, a power management system 805, a memory 806, a user interface 807, and a battery 808.

The mobile wireless communication device 800 can be used to communicate using a wide variety of communications technologies, including, but not limited to, 2G, 3G, 4G (including LTE, LTE-Advanced, and LTE-Advanced Pro), 5G NR and 5G Advanced, WLAN (for instance, Wi-Fi), WPAN (for instance, Bluetooth and ZigBee), WMAN (for instance, Wi-Max), and/or GPS technologies.

The transceiver 802 generates RF signals for transmission and processes incoming RF signals received from the antenna 804. It will be understood that various functionalities associated with the transmission and receiving of RF signals can be achieved by one or more components that are collectively represented in FIG. 20 as the transceiver 802. In one example, separate components (for instance, separate circuits or dies) can be provided for handling certain types of RF signals.

The FEM 803, i.e. the RF-FEM 400, aids in conditioning signals transmitted to and/or received from the antenna 804. In the illustrated embodiment, the FEM 803 includes antenna tuning circuitry 810, power amplifiers (PAs) 811, low rose amplifiers (LNAs) 812, filters 813, switches 814, and signal splitting/combining circuitry 815.

However, other implementations are possible. The filters 813 of the FEM 803 include one or more tunable filters with harmonic rejection that have one or more features of the embodiments disclosed herein. The tunable filters of the FEM 803 include a tunable ASM filter 464 of the RF-FEM 400 as shown in the block diagram of FIG. 20. For example, the FEM 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, duplexing or triplexing), or combinations thereof.

In certain implementations, the mobile wireless communication device 800 of FIG. 20 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and an include carriers separated in frequency within a common band or in different bands.

The antenna 804 shown in FIG. 20 can include one or more antennae used for a wide variety of communications. For example, the antenna 804 can include an antenna for transmitting and/or receiving signals associated with a wide variety of frequencies and communication standards.

In certain implementations, the antenna 804 shown in FIG. 20 supports MIMO communications and/or switched diversity communications. For example, MIMO communications use multiple antennae for communicating multiple data streams over a single radio frequency channel. MIMO communications benefit from higher signal-to-noise (SNR) ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennae based on a variety of factors, such as an observed bit error rate (BER) and/or a signal strength indicator.

The mobile wireless communication device 800 of FIG. 20 can operate with beamforming in certain implementations. For example, the FEM 803 can include amplifiers having controllable phase shifters with a controllable phase to provide beam formation and directivity for transmission and/or reception of signals using the antenna 804. For example, in the context of signal transmission, the amplitude and phases of the transmit signals provided to the antenna 804 are controlled such that radiated signals from the antenna 804 combine using constructive and destructive interference to generate an aggregate transmit signal exhibiting beam-like qualities with more signal strength propagating in a direction. In the context of signal reception, the amplitude and phases are controlled such that more signal energy is received when the signal is arriving at the antenna 804 from a particular direction. In certain implementation, the antennas 804 include one or more arrays of antenna elements to perform beamforming.

The baseband system 801 of the mobile wireless communication device 800 shown in FIG. 20 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received RF signals provided by the transceiver 802. As shown in FIG. 20, the baseband system 801 is coupled to the memory 806 to facilitate operation of the mobile wireless communication device 800. The memory 806 can be used for a wide variety of purposes, such as storing data and/or instructions to facilitate the operation of the mobile wireless communication device 800 and/or to provide storage of user information.

The power management system 805 provides a number of power management functions of the mobile wireless communication device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE). As shown in FIG. 20 the power management system 805 receives a battery voltage from the battery 808. The battery 808 can be any suitable battery for the mobile wireless communication device 800, including, for example, a lithium-ion battery.

While certain embodiments have been described, these embodiments have been presented by way of example only, and are not intended to limit the scope of the disclosure. Indeed, the novel filters, wireless communication devices, apparatus, methods, and systems described herein may be embodied in a variety of other forms. Furthermore, various omissions, substitutions and changes in the form of the filters, wireless communication devices, apparatus, methods, and systems described herein may be made without departing from the spirit of the disclosure.

1. A front-end module comprising:
a signal input configured to receive a radio-frequency (RF) signal;
an antenna switch module (ASM);
a power amplifier adapted to amplify the received RF signal to provide an amplified RF signal supplied to the ASM by way of one or more RF signal paths; and
a tunable filter with selective coupled resonances adapted to filter the RF signal output by the ASM to provide a filtered RF signal at an antenna node forming a signal output of the front-end module and configured to be coupled to an antenna.

2. The front-end module of claim 1 wherein the tunable filter is adapted to provide harmonic rejection of harmonic frequencies of the RF signal output by the ASM.

3. The front-end module of claim 1 wherein the tunable filter includes a first resonance circuit having a first inductor and a first capacitor being connected in parallel between a signal input and a signal output of the tunable filter.

4. The front-end module of claim 3 wherein the tunable filter includes a second resonance circuit having a second inductor and a second capacitor connected in series to each other between the signal output of the tunable filter and a reference potential.

5. The front-end module of claim 4 wherein the first resonance circuit and the second resonance circuit provide filtering of resonance frequencies of the tunable filter.

6. The front-end module of claim 5 further comprising a switchable filter element connected to the first resonance circuit and to the second resonance circuit.

7. The front-end module of claim 6 wherein the switchable filter element is adapted to couple the resonance frequency of the first resonance circuit and the resonance frequency of the second resonance circuit.

8. The front-end module of claim 7 wherein the switchable filter element is connected between the signal input of the tunable filter and a node between the second inductor and the second capacitor of the second resonance circuit.

9. The front-end module of claim 8 wherein the switchable filter element includes a switchable or tunable capacitor.

10. The front-end module of claim 9 wherein an inductor is connected in series to the switchable or tunable capacitor.

11. The front-end module of claim 9 wherein an inductor with switchable or tunable inductance is connected in parallel to the switchable or tunable capacitor.

12. The front-end module of claim 9 wherein the switchable or tunable capacitor includes a capacitor connected in series with a controllable switch.

13. The front-end module of claim 12 wherein the controllable switch includes a low off-capacitance in its switched-off state.

14. The front-end module of claim 4 wherein the first resonance circuit includes a tank circuit for rejecting a second harmonic frequency of the radio-frequency signal output by the ASM.

15. The front-end module of claim 4 wherein the second resonance circuit includes a trap circuit for rejecting a third harmonic frequency of the radio-frequency signal output by the ASM.

16. The front-end module of claim 4 further comprising a third resonance circuit connected between the coupled first and second resonance circuits and the signal output of the tunable filter.

17. The front-end module of claim 16 wherein the third resonance circuit includes a third inductor and a third capacitor connected in parallel to each other.

18. The front-end module of claim 16 further comprising a fourth resonance circuit connected between the coupled first and second resonance circuits and the signal input of the tunable filter, the fourth resonance circuit including a fourth inductor and a fourth capacitor connected in series to each other.

19. The front-end module of claim 3 wherein the first capacitor of the first resonance circuit includes a switchable or tunable capacitance.

20. The front-end module of claim 3 wherein the first inductor of the first resonance circuit includes a switchable or tunable inductance.

21. The front-end module of claim 1 wherein the tunable filter is adapted to provide an impedance matching at a fundamental frequency of the RF signal output by the ASM.
